(19) United States
(12) Patent Application Publication
(10) Pub. No.: US 2016/0137051 A1
(43) Pub. Date: May 19, 2016

(54) DRIVELINE FOR HYBRID VEHICLE

(71) Applicant: Delbert Tesar, Austin, TX (US)

(72) Inventor: Delbert Tesar, Austin, TX (US)

(21) Appl. No.: 14/942,895

(22) Filed: Nov. 16, 2015

Related U.S. Application Data
(60) Provisional application No. 62/079,964, filed on Nov. 14, 2014.

(51) Int. Cl. B60K 6/442

(52) U.S. Cl. CPC B60K 6/442; Y10S 903/903

(57) ABSTRACT

A hybrid vehicle (101) is provided which includes an internal combustion engine (109), an electric power source (115) and a plurality of multi-speed hub drive wheels (MDWs) (103, 105). Each MDW is transformable between a first state in which the MDWs are driven by the internal combustion engine, and a second state in which the MDW is driven by the electrical power source.

### CROSS-REFERENCE TO RELATED APPLICATION

This application claims the benefit of priority of U.S. provisional application Ser. No. 62/079,964, filed Nov. 14, 2014, having the same inventor and the same title, and which is incorporated herein by reference in its entirety.

### FIELD OF THE DISCLOSURE

The present disclosure relates generally to hybrid vehicles, and more particularly to a driveline for hybrid vehicles featuring multi-speed hub drive wheels (MDWs).

### BACKGROUND OF THE DISCLOSURE

Hybrid vehicles utilize multiple, distinct power sources to produce motive energy. To date, a variety of hybrid vehicles have been produced, many of which combine an internal combustion engine with one generator and one or more electric motors. For example, many automobile manufacturers currently offer hybrid versions of their gasoline powered models.

### BRIEF DESCRIPTION OF THE DRAWINGS

FIG. 1 is a schematic illustration of a driveline for an open architecture reconfigurable hybrid automobile.

FIG. 2 is a schematic illustration of a driveline for an open architecture reconfigurable hybrid combat vehicle.

### SUMMARY OF THE DISCLOSURE

In one aspect, a vehicle is provided which comprises (a) an internal combustion engine; (b) an electrical power source; and (c) a plurality of multi-speed hub drive wheels (MDWs). Each MDW is transformable between a first state in which the MDW is driven mechanically by the internal combustion engine, and a second state in which the MDW is driven by the electrical power source.

### DETAILED DESCRIPTION

Despite the advances in hybrid vehicles, a number of needs persist in the art. For example, many hybrid vehicles offer less than optimal maneuverability, safety, traction and/or fuel consumption for a given set of operating conditions. This is frequently due to the passive driveline designs such vehicles typically contain, which often entail limited choices about which of these (often competing) parameters are to be emphasized in a vehicle's overall design.

There is thus a need in the art for vehicles which allow these parameters to be adjusted on the fly, and in response to current driving conditions. Moreover, there is a need in the art to extend this adjustment individually to each wheel, thus allowing for more localized adjustment, better response to equipment failure, and other advantages. There is also a need in the art to allow each wheel (or at least some of the wheels such as, for example, the wheels in the front set of wheels) to be operated in a hybrid manner, and to allow the multiple power sources to operate a wheel in parallel, separately or concurrently. There is further a need in the art for an open architecture for drivelines that will permit standardization of all driveline components. These and other needs may be met by the systems, devices and methodologies disclosed herein.

It has now been found that the foregoing needs may be met through a hybrid vehicle which utilizes multi-speed hub drive wheels (MDWs) to maximize driver choices, while also providing completely independent real-time torque control at each wheel. In a preferred embodiment, such a vehicle comprises (a) one or more internal combustion engines; (b) an electrical power source; and (c) a plurality of multi-speed hub drive wheels (MDWs). Each MDW is transformable between a first state in which the MDW is driven mechanically by the internal combustion engine (or engines), and a second state in which the MDW is driven by an electrical power source.

This approach may be utilized to maximize vehicle maneuverability, enhance safety, maximize traction, reduce fuel consumption, and permit standardization of all driveline components. The open architecture permitted by this approach may be built using exceptional mechanical/electric drive technology that permits purely mechanical modes (for maximum cruise efficiency) and/or purely electrical modes (for enhanced efficiency in urban duty cycles). Moreover, these modes may be mixed by acting in parallel.

Various MDWs, rotary actuators, and components thereof may be utilized in the systems, methodologies and devices (including vehicles) described herein. Examples of such MDWs, rotary actuators, and components are disclosed, for example, in commonly assigned U.S. Ser. No. 14/195,847 (Tesar), filed on Mar. 3, 2014 and entitled “Multi-Speed Hub Drive Wheels”, which is incorporated herein by reference in its entirety; in U.S. 62/246,301 (Tesar), filed on Oct. 26, 2015 and entitled “Simplified Parallel Eccentric Rotary Actuator”, which is also incorporated herein by reference in its entirety; in U.S. Ser. No. 14/869,994 (Tesar), filed on Sep. 29, 2015, entitled “Compact Parallel Eccentric Rotary Actuator”, which is also incorporated herein by reference in its entirety; and in U.S. Ser. No. 14/732,286 (Tesar), filed on Jun. 5, 2015, entitled “Modified Parallel Eccentric Rotary Actuator”, which is also incorporated herein by reference in its entirety.

Preferably, the MDWs utilized in the vehicles described herein feature a two-speed gear train which uses a rugged and compact arrangement (the star compound) with a servo controlled synchro clutch, standard gear manufacture (helical teeth), and a large diameter small cross-section bearing (the shortest force path between the suspension and the wheel hub) for exceptional ruggedness. Preferably, a switched reluctance motor is utilized to drive each wheel to provide high shock and temperature tolerance at low cost.

In a preferred embodiment, the MDW has a two-speed drive which may reduce energy losses by 2× or more for both city and highway duty cycles over a single speed electric wheel drive. In an exemplary instance of such an embodiment, each MDW may be configured to provide a power output of 40 hp and may provide an acceleration of 1 g over speeds of up to 25 mph in first gear, and 0.5 g in second gear to obtain a 4 to 5 second acceleration period up to 60 mph. Hence, the MDWs disclosed herein may provide both high efficiency and very attractive drivability for the discerning customer.

One of the goals of the systems, devices and methodologies disclosed herein is to enable the internal combustion engine to operate at its tuned RPM, thereby maximizing its efficiency. At that speed, the engine preferably drives a generator which is also tuned at that RPM for maximum efficiency. This generated power may be transferred to an on-board storage battery.

The internal combustion engine may be connected through a 1-to-1 differential to drive the front wheels of the vehicle. These front wheels also preferably contain a 2-speed MDW. A slip clutch is preferably provided at the front end of the MDW to enable on-demand coupling between the motor-operated drive shaft and the MDW rotor. If the MDW stator is not energized, then the drive shaft may independently drive the wheels through the 2-speed gear reducer in the MDW. Alternatively, the slip clutch may be disengaged to enable only the stator to drive the rotor to connect to the wheel through the two-speed gear train. In some embodiments, and under some operation conditions, both the drive shaft and the stator may drive the wheel in parallel. This mode of operation may provide maximum torque when required for high acceleration, high gradability, or high drawbar pull.

The foregoing configuration provides the operator of a vehicle with a very wide range of reconfiguration choices, few (if any) of which currently exist for passive mechanical drives or for most hybrid electric vehicles. For example, in some of the embodiments described above, the mechanical drive may be used exclusively when the vehicle is cruising at highway speeds, while in urban settings, the electrical drive may be used exclusively. Similarly, the mechanical and electrical drives may be used in combination in certain situations such as, for example, to maximize acceleration or to improve climbing capability.

The systems, methodologies and devices disclosed herein have significant beneficial effects on vehicles as a whole. For example, in a vehicle having a normal front-wheel drive system and equipped with MDWs of the type disclosed herein, the tuned internal combustion engine may now be much smaller, since it is not solely responsible for drivability. A transmission system of the conventional type is also no longer necessary, since the speed changes occur in the wheels. The front wheels are preferably driven in parallel, both mechanically and electrically within each wheel. The rear wheels are preferably driven electrically by the MDWs.

The systems, methodologies and devices disclosed herein may be utilized to maximize choices for all customer requirements. These choices may include choices about efficiency (the balanced combination of electrical and mechanical drives for all duty cycles), traction (real-time traction control at each wheel depending on contact force and available surface friction), drivability (acceleration and gradability benefit from using all available drive torques balanced by real-time decision software), and safety (emergency response scenarios to use all MDW torques to best respond to driver commands, environmental or road conditions and vehicle stability requirements, especially on poor road surfaces or in poor weather).

The systems, methodologies and devices disclosed herein may also be utilized to reduce or eliminate single-point failures in a vehicle (that is, failures which stop the vehicle with no operational reconfigurations to avoid the fault), and thus address a long-felt but unfulfilled need in the art. In a preferred embodiment, the driver system disclosed herein has no single-point failures. In particular, if the internal combustion engine and mechanical driveline fails, then the electrical system may operate the vehicle until the vehicle is in a safe location and/or can be repaired (possibly by a quick plug-and-play operation). Of course, if the electrical system fails, then the mechanical system may take over. In low drivability demands, only two wheels may operate. If one wheel fails, then three wheels may operate, while the failed wheel is put into neutral. In turning, the heavily loaded front wheel may provide more “peak” torque to enhance traction and, therefore, safety.

Intelligent decision making software may be provided with the systems, methodologies and devices disclosed herein to ensure that all wheel torques are properly balanced (preferably in the millisecond regime) against available traction forces. The number of choices available to the system or driver in such embodiments may be significant, with different (possibly independently selectable) possible combinations of features leading to numerous possible permutations. In such systems, methodologies and devices, it may be feasible to provide active suspension control to manage, for example, 50% of the contact force level at each wheel. The dependence on passive shock absorbers typical in prior art vehicles may be reduced or eliminated, since all critical elements in the passive drivelines disclosed herein may become active and under the direct control of the operator.

In the systems, methodologies and devices disclosed herein, the MDWs may be produced as discrete sets, wherein each member of a set provides predefined performance characteristics. For example, the MDWs may be provided as interchangeable 16, 20, 24, 30, or 40 hp devices, thus allowing a customer to select a desired performance level at the time of purchase or upgrade. The MDWs are preferably designed to allow rapid change-out, thus allowing a consumer to easily change the performance characteristics of a vehicle at any time by a simple exchange of MDWs. Any previously used MDWs may then be traded like any other viable used product on the market. Indeed, the vehicle body, engine, generator, battery, controller modules, and other vehicle components may be designed in a similar manner to become tradable modules separate from the rest of the vehicle.

It will be appreciated from the foregoing that the systems, methodologies and devices disclosed herein may have a profound impact on the cost and maintenance of vehicle architectures. In particular, these systems, methodologies and devices may allow the engine to become lighter, and to preferably run primarily at one speed in order to maintain its efficiency sweet spot. These systems, methodologies and devices also obviate the need for a central transmission, and may allow the generator and battery to be sized at a finite number of power levels (e.g., a minimum set). The front wheel slip clutch/MDW combination preferably becomes a standard in a minimum set of horsepower levels (e.g., 5). The rear wheel MDWs also preferably becomes standardized in a minimum set. The foregoing standardizations may now provide in-depth certification for minimum cost and high production levels. These minimum sets may also enable OEMs to manage a responsive supply chain populated by competing producers generating components of ever-increasing performance/cost ratios, ina manner similar to that's een in the computer industry two decades ago. All of the foregoing suggests that a revolution for automobile production is now not only feasible with the systems, devices and methodologies disclosed herein, but is highly desirable to maximize operator choice, reduce vehicle cost, and raise gasoline mileage.

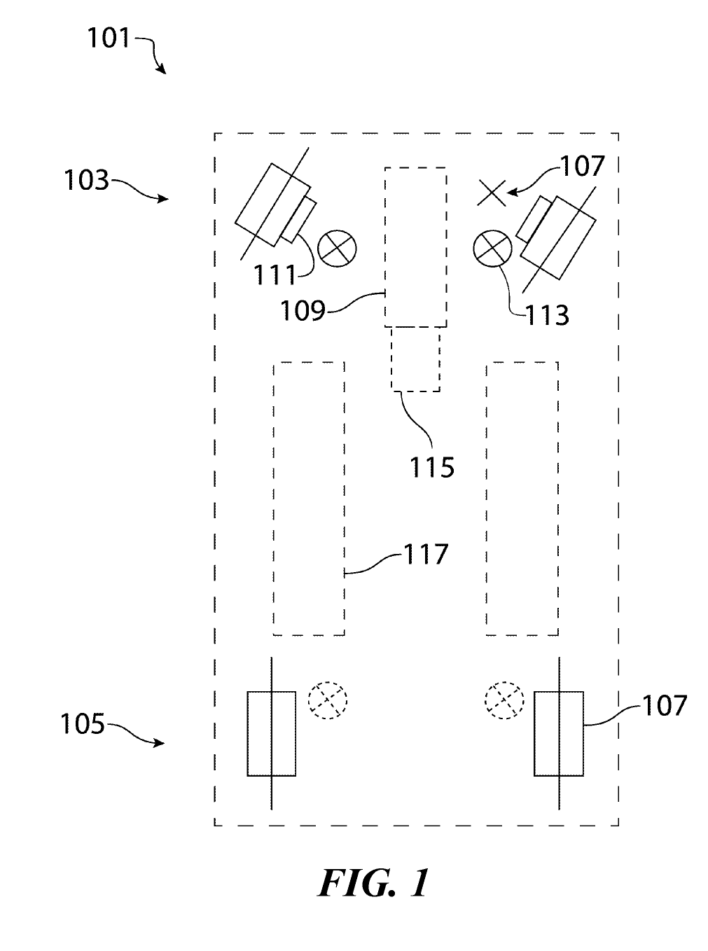

The systems, devices and methodologies disclosed herein may be further understood with reference to FIG. 1, which depicts a particular, non-limiting embodiment of a light vehicle comprising a driveline of the type disclosed herein. The vehicle 101 depicted therein comprises a front set of steered MDW driven wheels 103 and a rear set of non-steered MDW driven wheels 105. All of the wheels 103, 105 are equipped with an MDW of the type disclosed herein. In the particular embodiment depicted, the front set of MDW driven wheels 103 and the rear set of non-steered MDW driven wheels 105 each have two members, although various embodiments are possible in accordance with the teachings herein in which either set may independently have only one member or more than three members.

The front wheels 103 may also be driven mechanically by a differential 107 (which is preferably a 1-to-1 differential) connected to a tuned engine 109. The engine 109 is preferably an internal combustion engine such as, for example, a gasoline powered engine or light diesel engine, although other engine types may also be utilized in the systems devices and methodologies disclosed herein. Each of the front wheels 103 is also equipped with a slip clutch 111 and a steering mechanism (not shown) and, in some embodiments, may be equipped with an active suspension 113. In the particular embodiment depicted, the vehicle is further provided with a high efficiency generator 115 and dual battery packs 117, it being understood that various battery packs and arrays (with various numbers of batteries or cells of various sizes or geometries) may be used in a vehicle made in accordance with the teachings herein. Notably, the vehicle 101 lacks a mechanical transmission or driveline of the type found in conventional vehicles.

The driveline architecture of the vehicle 101 depicted in FIG. 1 may be utilized to develop a vehicle with desirable or optimized maneuverability, reduced weight and desirable or optimized traction, and provides for operation under faults or damage. Moreover, this architecture may be implemented as an open architecture in which all driveline components are standardized to enhance performance/cost ratios and to enable rapid assembly, repair, and accelerated refreshment. The architecture may be built on dedicated driveline systems which run in parallel (either purely mechanical, purely electrical, or both), where all wheels are completely independent for on-road and cross country operations.

In a preferred embodiment, the driveline architecture of the vehicle depicted in FIG. 1 utilizes three unique classes of actuators, namely, low complexity/low-cost actuators (for steering/camber), MDWs (for wheel torque), and parallel eccentrics (for active suspensions). Each actuator may be considered as a standard plug-and-play module. These modules may be highly certified and provided by a responsive supply chain. The tech base for each class then becomes a competitive strategy for these suppliers to ensure continuous growth in their performance-to-cost ratios (similar to the self-fulfilling Moore's law for computer chips).

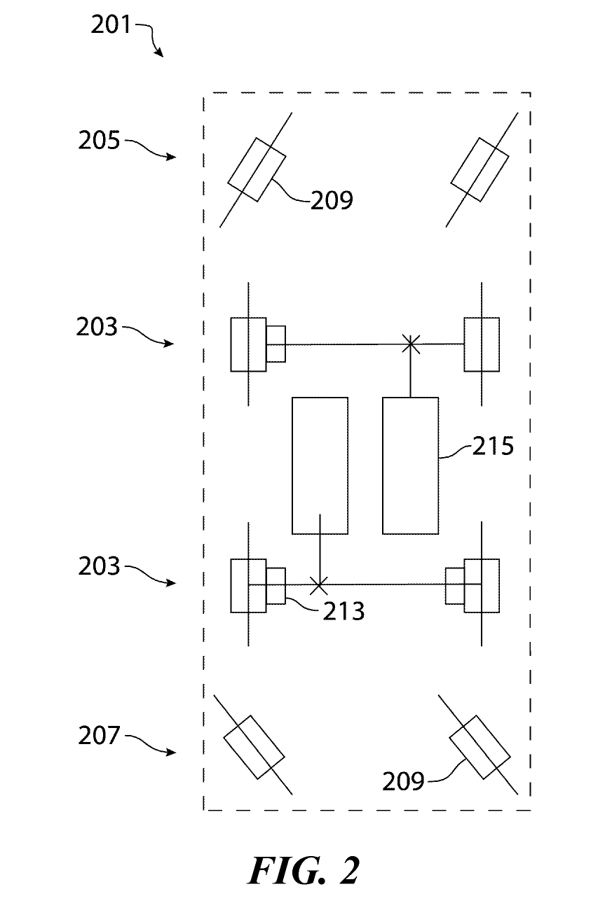

FIG. 2 depicts a particular, non-limiting embodiment of a combat vehicle comprising a driveline architecture of the type disclosed herein. The vehicle 201 depicted therein comprises a set of four cambered parallel mechanical/electrical hub drive wheels 203, a front set of steerable wheels 205, and a rear set of steerable wheels 207. All of the wheels 203, 205 and 207 are equipped with an MDW 209 of the type disclosed herein. The front wheels 205 and rear wheels 207 are driven electrically driven, while each of the cambered wheels 203 is equipped with a slip clutch 213 and is driven mechanically and/or electrically. Mechanical power to the cambered wheels 203 is provided by a drive shaft which is driven by light diesel engines 215, preferably at a 1-to-1 differential. All of the wheels 203, 205 and 207 employ high torque density active suspensions.

The advantages of the foregoing embodiment may be appreciated by considering conventional armored battlefield vehicles and the requirements that govern their designs. Tracked vehicles excel at weights above 30 tons in very rough terrain, but do not do well in certain situations and conditions such as hill traverses, in muddy hollows, and on ice. Their turn-on-a-dime-by-skid steering doubles power requirements, but the loss of one track results in mobility-kill (and thus represents a single point of failure).

Below 30 tons, armored wheel vehicles are quite competitive. The concept of a TWIRE (combined track, wheel, and tire) can provide (on demand) high speed, low fuel usage, road movement (with high tire contact pressure) and low contact pressure fraction (below 15 psi—comparable to a tracked vehicle) on soft terrain. Currently, these 20-30 ton wheeled vehicles have all wheels driven with the use of multiple (but complex and heavy) transfer boxes. The dilemma this raises is that all wheels are equally and passively driven (with modest variation using slip differentials). No active control can be provided, although ABS is now providing independent wheel braking (although this is to stop, not to accelerate and respond to traction demands from the uneven terrain). Hence, independently controlled wheels (steered, cambered, active suspension and torque driven) are now called the intelligent corner. This concept has now become a standardized module to create families of battlefield vehicles from 20 to 70 tons with 4 to 14 pairs of two intelligent corners.

An extremely versatile driveline system, such as that depicted in FIG. 2, may be provided for combat vehicles, and may be implemented as, for example, an 8-wheeled (TWIREd) vehicle. It is desirable for on-road operation to have a very simple mechanical driveline to the two (or more) mid-axles with direct drives from very efficient light diesel engines that are tuned for highway speeds. This may drive four or more inner wheels. The steered front and rear wheels may then be unpowered and in neutral. Each mechanically powered wheel will preferably have four mechanical speeds and a slip clutch to drive the rotor of an electric drive wheel with an un-powered stator.

In complex off-road terrains, a full electrical system may be energized (which will preferably include generators, batteries and electric drive wheels), and the electric drive wheels may be utilized to augment the mechanically/electrically driven mid-axle wheels (in parallel). The inner wheels preferably act in parallel to either be all mechanical, all electrical, or both. The steered front and rear wheels are preferably only electrically driven to simplify the mechanical driveline subsystem. Nonetheless, the number of independent choices to the operator of such a vehicle rises beyond 2000 meaningful choices.

One skilled in the art will appreciate that the systems devices and methodologies disclosed herein may find application in a wide variety of vehicles. These include, without limitation, automobiles, fleet vehicles, trucks (including 18-wheel rigs) and military vehicles such as, for example troop carriers.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims. It will also be appreciated that the various features set forth in the claims may be presented in various combinations and sub-combinations in future claims without departing from the scope of the invention. In particular, the present disclosure expressly contemplates any such combination or sub-combination that is not known to the prior art, as if such combinations or sub-combinations were expressly written out.

What is claimed is:

1. A vehicle, comprising:
an internal combustion engine;
an electrical power source; and
a plurality of multi-speed hub drive wheels (MDWs);
wherein each MDW is transformable between a first state in which the MDW is driven mechanically by the internal combustion engine, and a second state in which the MDW is driven by the electrical power source.

2. The vehicle of claim 1, further comprising:
a drive shaft powered by said internal combustion engine.

3. The vehicle of claim 1, wherein each MDW is equipped with a rotor and a stator.

4. The vehicle of claim 3, wherein each MDW is equipped with a clutch which provides on-demand coupling between the drive shaft and the rotor of the MDW.

5. The vehicle of claim 4, wherein said clutch is a slip clutch.

6. The vehicle of claim 4, wherein the stator is not energized when the MDW is in the first state, and wherein the stator is energized when the MDW is in the second state.

7. The vehicle of claim 6, wherein the clutch couples the drive shaft to the rotor of the MDW when the MDW is in the first state.

8. The vehicle of claim 6, wherein the clutch disengages the drive shaft from the rotor of the MDW when the MDW is in the second state.

9. The vehicle of claim 1, wherein each MDW is driven solely by the internal combustion engine when it is in the first state, and wherein each MDW is driven solely by the electrical power source when it is in the second state.

10. The vehicle of claim 1, wherein each MDW is transformable between a first state in which the MDW is driven solely by the internal combustion engine, a second state in which the MDW is driven solely by the electrical power source, and a third state in which the MDW is driven by both the internal combustion engine and the electrical power source.

11. The vehicle of claim 2, wherein said internal combustion engine is connected to said drive shaft by way of a 1-to-1 differential.

12. The vehicle of claim 1, wherein each MDW comprises a 2-speed gear reducer.

13. The vehicle of claim 1, wherein said plurality of MDWs comprises:
a first set of multi-speed hub drive wheels (MDWs) which is driven solely by said electrical power source; and
a second set of MDWs which is driven by said internal combustion engine and by a switched reluctance motor powered by said electric power source.

14. The vehicle of claim 13, wherein said first set of wheels is a rear set of wheels, and wherein said second set of wheels is a front set of wheels, and wherein said second set of wheels is driven in parallel by both said switched reluctance motor and by said internal combustion engine.

15. The vehicle of claim 1, wherein each MDW includes a switched reluctance motor.

16. The vehicle of claim 1, wherein each MDW includes a 2-speed gear train.

17. The vehicle of claim 1, wherein each MDW includes a star compound gear train.

18. The vehicle of claim 17, wherein each MDW includes a servo controlled synchro clutch.

19. The vehicle of claim 1, wherein each MDW is a 4-speed MDW and provides at least a 2× reduction in losses.

20. The vehicle of claim 1, wherein each MDW is independently transformable between said first and second states.
